(19) United States
(12) Patent Application Publication
(10) Pub. No.: US 2007/0274297 A1
(43) Pub. Date: Nov. 29, 2007

(54) STREAMING AUDIO FROM A FULL-DUPLEX NETWORK THROUGH A HALF-DUPLEX DEVICE

(76) Inventors: Charles W. Cross JR., Wellington, FL (US); Yan Li, Boynton Beach, FL (US); Gerald M. McCobb, Delray Beach, FL (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/382,583

(22) Filed: May 10, 2006

(51) Int. Cl. H04L 12/66

(52) U.S. Cl. 370/356

(57) ABSTRACT

Streaming audio from a full-duplex network through a half-duplex device, including buffering, in the half-duplex device, input audio from the full-duplex network, where the input audio includes audio data for output through the half-duplex device; playing, through the half-duplex device, the buffered input audio; pausing, during voice activity on the half-duplex device, the playing of the buffered input audio; recording, during the voice activity, output audio to be sent to the full-duplex network; and resuming the playing of the buffered input audio after the voice activity.

### BACKGROUND OF THE INVENTION

1. Field of the Invention

The field of the invention is data processing, or, more specifically, methods, apparatus, and products for streaming audio from a full-duplex network through a half-duplex device.

2. Description Of Related Art

User interaction with applications running on small devices through a keyboard or stylus has become increasingly limited and cumbersome as those devices have become increasingly smaller. In particular, small handheld devices like mobile phones and PDAs serve many functions and contain sufficient processing power to support user interaction through other modes, such as multimodal access. Devices which support multimodal access combine multiple user input modes or channels in the same interaction allowing a user to interact with the applications on the device simultaneously through multiple input modes or channels. The methods of input include speech recognition, keyboard, touch screen, stylus, mouse, handwriting, and others. Multimodal input often makes using a small device easier.

Multimodal applications often run on servers that serve up multimodal web pages for display on a multimodal browser. A ‘multimodal browser,’ as the term is used in this specification, generally means a web browser capable of receiving multimodal input and interacting with users with multimodal output. Multimodal browsers typically render web pages written in XHTML+Voice (‘X+V’). X+V provides a markup language that enables users to interact with a multimodal application often running on a server through spoken dialog in addition to traditional means of input such as keyboard strokes and mouse pointer action. X+V adds spoken interaction to standard web content by integrating XHTML (extensible Hypertext Markup Language) and speech recognition vocabularies supported by VoiceXML. For visual markup, X+V includes the XHTML standard. For voice markup, X+V includes a subset of VoiceXML. For synchronizing the VoiceXML elements with corresponding visual interface elements, X+V uses events. XHTML includes voice modules that support speech synthesis, speech dialogs, command and control, and speech grammars. Voice handlers can be attached to XHTML elements and respond to specific events. Voice interaction features are integrated with XHTML and can consequently be used directly within XHTML content.

The performance of speech recognition systems receiving speech that has been transmitted over voice channels, particularly mobile channels, can be significantly degraded when compared to using an unmodified signal. The degradations are as a result of both relatively low bit rate speech coding and channel transmission errors. A Distributed Speech Recognition (‘DSR’) system addresses these problems by eliminating the speech channel and instead using an error protected data channel to send a parameterized representation of the speech, which is suitable for recognition. The processing is distributed between terminal or client device and a voice server. The client performs the feature parameter extraction—the front-end of the speech recognition function. The speech features then are transmitted over a data channel to a remote back-end recognizer or speech recognition engine on a voice server. This architecture substantially reduces transmission channel effects on speech recognition performance.

In many instances of client devices, however, the client device is capable of half-duplex communication only. That is, the client device may accept audio input from a user or deliver audio output to a user but cannot do both at the same time. The data communications full-duplex network that connects the half-duplex device to a voice server typically is a full-duplex network, capable of sending data and receiving data to and from a client device both at the same time. In such a system, during a period when a user provides voice activity to be digitized, parameterized, and sent to a voice server for voice recognition, audio input from the voice server that arrives through the full-duplex network at the half-duplex device while the user is speaking is lost.

### SUMMARY OF THE INVENTION

Methods, apparatus, and computer program products are described for streaming audio from a full-duplex network through a half-duplex device that include buffering, in the half-duplex device, input audio from the full-duplex network, where the input audio includes audio data for output through the half-duplex device; playing, through the half-duplex device, the buffered input audio; pausing, during voice activity on the half-duplex device, the playing of the buffered input audio; recording, during the voice activity, output audio to be sent to the full-duplex network; and resuming the playing of the buffered input audio after the voice activity.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for streaming audio from a full-duplex network through a half-duplex device according to embodiments of the present invention.

FIG. 2 sets forth a block diagram of automated computing machinery comprising an example of a computer useful as a voice server in streaming audio from a full-duplex network through a half-duplex device according to embodiments of the present invention.

FIG. 3 sets forth a block diagram of automated computing machinery comprising an example of a computer useful as a half-duplex device in streaming audio from a full-duplex network through a half-duplex device according to embodiments of the present invention.

FIG. 4 sets forth a functional block diagram of exemplary apparatus for streaming audio from a full-duplex network through a half-duplex device according to embodiments of the present invention.

FIG. 5 sets forth a flow chart illustrating an exemplary method of streaming audio from a full-duplex network through a half-duplex device according to embodiments of the present invention.

### DETAILED DESCRIPTION OF EXEMPLARY EMBODIMENTS

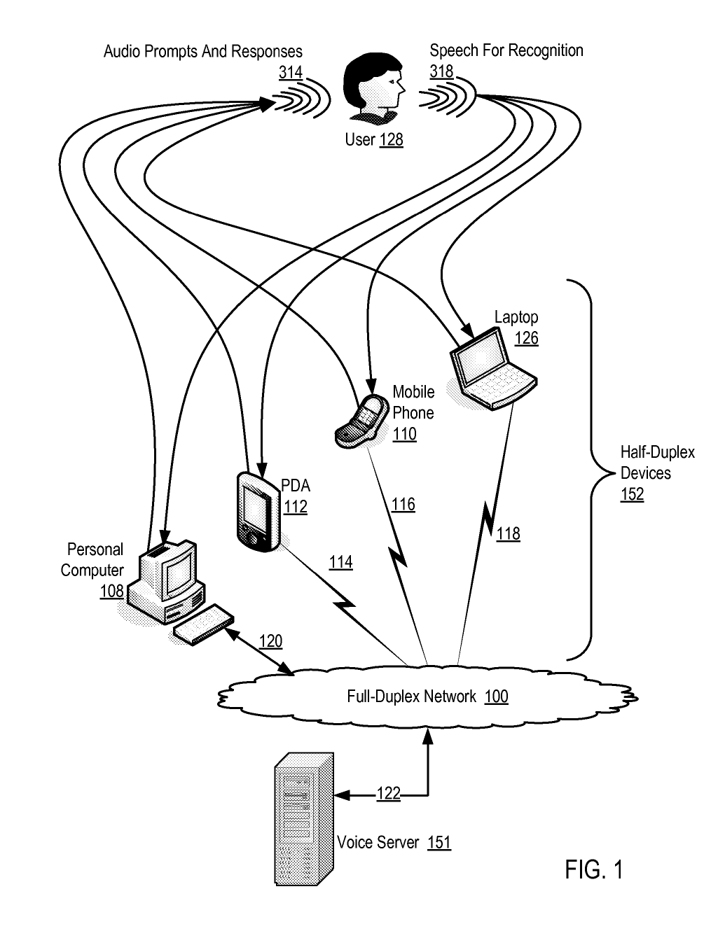

Exemplary methods, apparatus, and products for streaming audio from a full-duplex network through a half-duplex device according to embodiments of the present invention are described with reference to the accompanying drawings, beginning with FIG. 1. FIG. 1 sets forth a network diagram illustrating an exemplary system for streaming audio from a full-duplex network through a half-duplex device according to embodiments of the present invention. The system of FIG. 1 operates generally to stream audio from a full-duplex network (100) through a half-duplex device (152) according to embodiments of the present invention by buffering, in a half-duplex device (152), input audio from the full-duplex network (100), where the input audio includes audio data for output through the half-duplex device; playing, through the half-duplex device, the buffered input audio; pausing, during voice activity on the half-duplex device, the playing of the buffered input audio; recording, during the voice activity, output audio to be sent to the full-duplex network; and resuming the playing of the buffered input audio after the voice activity. In this example, input audio from the full-duplex network is implemented as Voice Over Internet Protocol (‘VOIP’).

A half-duplex device is an automated device, automated computing machinery, or a computer program running on an automated device that is capable of accepting speech input and streaming digitized speech to a voice server for recognition. The digitized speech may be compressed according to telephony industry standard codecs, including those used for Distributed Speech Recognition. A voice-enabled browser on a laptop, a voice browser on a telephone handset, an online game implemented with Java on a personal computer, for example, all may be implemented as half-duplex devices.

The system of FIG. 1 includes several example half-duplex devices:
personal computer (108) which is coupled for data communications to full-duplex network (100) through wireline connection (120),
personal digital assistant (‘PDA’) (112) which is coupled for data communications to full-duplex network (100) through wireless connection (114),
mobile telephone (110) which is coupled for data communications to full-duplex network (100) through wireless connection (116), and
laptop computer (126) which is coupled for data communications to full-duplex network (100) through wireless connection (118).

Each of the half-duplex devices (152) in the example of FIG. 1 includes a distributed speech recognition (‘DSR’) client. Each of the example half-duplex devices (152) in the system of FIG. 1 includes a microphone, an audio amplifier, a digital-to-analog converter, and a DSR client software application capable of accepting from a user (128) speech for recognition (318), parameterizing the speech by extracting speech parameters, and sending the speech to a voice server (151) for recognition. The half-duplex devices in this example are also typically capable of employing voice activity detection (‘VAD’) to distinguish voice activity from non-voice audio signals and identify only the voice activity as speech to be transmitted for recognition.

Each of the example half-duplex devices (152) in the system of FIG. 1 is capable of streaming audio from a full-duplex network through a half-duplex device according to embodiments of the present invention by buffering, in the half-duplex device, input audio from the full-duplex network, where the input audio is composed of audio data for output through the half-duplex device; playing, through the half-duplex device, the buffered input audio; pausing, during voice activity on the half-duplex device, the playing of the buffered input audio; recording, during the voice activity, output audio to be sent to the full-duplex network; and resuming the playing of the buffered input audio after the voice activity. The use of these four example half-duplex devices (152) is for explanation only, not for limitation of the invention. Any automated computing machinery capable of accepting speech from a user, sending the speech to a voice server, and receiving and playing speech prompts and responses from the voice server may function as a half-duplex device for streaming audio from a full-duplex network according to embodiments of the present invention.

The system of FIG. 1 also include a voice server (151) which is connected to full-duplex network (100) through full-duplex wireline connection (122). The voice server (151) is a computer that runs a DSR server application program that accepts requests for speech recognition and returns text representing recognized speech. Voice server (151) also provides text to speech (‘TTS’) conversion for voice prompts and voice responses (314) to user input in DSR client applications such as, for example, X+V applications or Java Speech applications.

The system of FIG. 1 includes a full-duplex network (100) that connects the half-duplex devices (152) and the voice server (151) for data communications. A full-duplex network for streaming audio from a full-duplex network through a half-duplex device according to embodiments of the present invention is a data communications full-duplex network composed of a plurality of computers that function as data communications routers connected for data communications with a packet switching protocols. Such a full-duplex network may be implemented with optical connections, wireline connections, or with wireless connections. Such a full-duplex network may include intranets, internets, local area full-duplex networks (‘LANs’), and wide area full-duplex networks (‘WANs’). Such a full-duplex network may implement:
a link layer with the Ethernet™ Protocol or the Wireless Ethernet™ Protocol,
a full-duplex network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The arrangement of the voice server (151), the half-duplex devices (152), and the full-duplex network (100) making up the exemplary system illustrated in FIG. 1 are for explanation, not for limitation. Data processing systems useful for streaming audio from a full-duplex network through a half-duplex device according to various embodiments of the present invention may include additional servers, routers, other devices, and peer-to-peer architectures, not shown in FIG. 1, as will occur to those of skill in the art. Full-duplex networks in such data processing systems may support many data communications protocols in addition to those noted above. Various embodiments of the present invention may be implemented on a variety of hardware platforms in addition to those illustrated in FIG. 1.

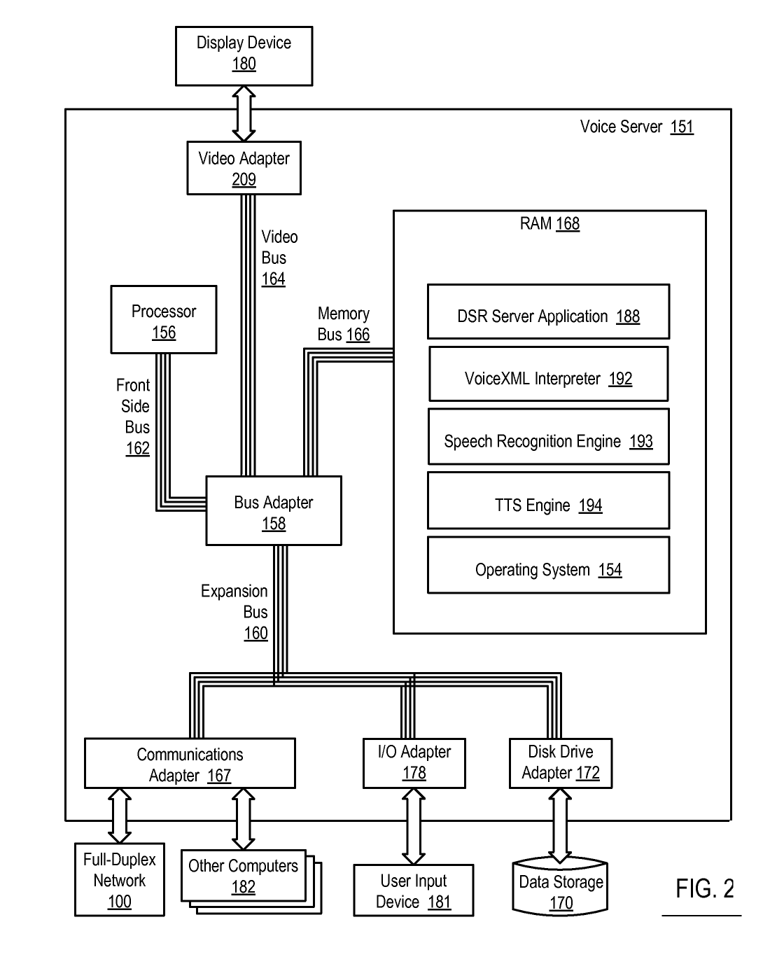

Streaming audio from a full-duplex network through a half-duplex device in accordance with the present invention is generally implemented with one or more voice servers, computers, that is, automated computing machinery, that carries out distributed speech recognition (‘DSR’). For further explanation, therefore, FIG. 2 sets forth a block diagram of automated computing machinery comprising an example of a computer useful as a voice server (151) in streaming audio from a full-duplex network through a half-duplex device according to embodiments of the present invention. The voice server (151) of FIG. 2 includes at least one computer processor (156) or ‘CPU’ as well as random access memory (168) (‘RAM’) which is connected through a high speed memory bus (166) and bus adapter (158) to processor (156) and to other components of the voice server.

Stored in RAM (168) is a DSR server application (188), a module of computer program instructions capable of operating a voice server in a system that streams audio from a full-duplex network through a half-duplex device according to embodiments of the present invention by streaming audio as VOIP through a full-duplex network to a half-duplex device. DSR server application (188) typically is a user-level, multimodal, server-side computer program. DSR server application (188) may, for example, be implemented with a set of VoiceXML documents which taken together comprise a VoiceXML application. DSR server application (188) may, for example, alternatively be implemented as a web server that supports X+V by providing responses to HTTP requests from X+V clients.

Also stored in RAM is a VoiceXML interpreter (192), a module of computer program instructions that parses and executes VoiceXML. VoiceXML input to VoiceXML interpreter (192) may originate from VoiceXML clients of half-duplex devices or from X+V clients of half-duplex devices. In this example, VoiceXML interpreter (192) interprets and executes VoiceXML segments provided to VoiceXML interpreter (192) through DSR server application (188).

Also stored in RAM (168) is a speech recognition engine (193), a module of computer program instructions that accepts digitized speech for recognition as preprocessed by a half-duplex device, converts the digitized speech to text, parses the converted speech against a vocabulary or grammar, and returns text representing recognized speech. Also stored in RAM (168) is a Text To Speech (‘TTS’) Engine (194), a module of computer program instructions that accepts text as input and returns the same text in the form of digitally encoded speech, for use in providing speech as prompts for and responses to users of DSR systems. In this example, such digitally encoded speech is provided by the voice server for streaming as input audio in the form of VOIP through a full-duplex network to a half-duplex device.

Also stored in RAM (168) is an operating system (154). Operating systems useful in voice servers according to embodiments of the present invention include UNIX™, Linux™, Microsoft NT™, AIX™, IBM's i5/OS™, and others as will occur to those of skill in the art. Operating system (154), DSR server application (188), VoiceXML interpreter (192), speech recognition engine (193), and Text To Speech Engine (194) in the example of FIG. 2 are shown in RAM (168), but many components of such software typically are stored in non-volatile memory also, for example, on disk drive (170).

Voice server (151) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in voice servers according to embodiments of the present invention include the Intel Northbridge, the Intel Memory Controller Hub, the Intel Southbridge, and the Intel I/O Controller Hub. Examples of expansion buses useful in voice servers according to embodiments of the present invention include Industry Standard Architecture (‘ISA’) buses and Peripheral Component Interconnect (‘PCI’) buses.

Voice server (151) of FIG. 2 includes disk drive adapter (172) coupled through expansion bus (160) and bus adapter (158) to processor (156) and other components of the voice server (151). Disk drive adapter (172) connects non-volatile data storage to the voice server (151) in the form of disk drive (170). Disk drive adapters useful in voice servers include Integrated Drive Electronics (‘IDE’) adapters, Small Computer System Interface (‘SCSI’) adapters, and others as will occur to those of skill in the art. In addition, non-volatile computer memory may be implemented for a voice server as an optical disk drive, electrically erasable programmable read-only memory (so-called ‘EEPROM’ or ‘Flash’ memory), RAM drives, and so on, as will occur to those of skill in the art.

The example voice server of FIG. 2 includes one or more input/output (‘I/O’) adapters (178). I/O adapters in voice servers implement user-oriented input/output through, for example, software drivers and computer hardware for controlling output to display devices such as computer display screens, as well as user input from user input devices (181) such as keyboards and mice. The example voice server of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary voice server (151) of FIG. 2 includes a communications adapter (167) for data communications with other computers (182) and for data communications with a full-duplex network (100). Such data communications may be carried out serially through through RS-232 connections, through external buses such as a Universal Serial Bus (‘USB’), through data communications full-duplex networks such as IP full-duplex networks, and in other ways as will occur to those of skill in the art. Communications adapters implement the hardware level of data communications through which one computer sends data communications to another computer, directly or through a full-duplex network. Examples of communications adapters useful for streaming audio through a full-duplex network to a half-duplex device according to embodiments of the present invention include modems for wired dial-up communications, Ethernet (IEEE 802.3) adapters for wired full-duplex network communications, and 802.11 adapters for wireless full-duplex network communications.

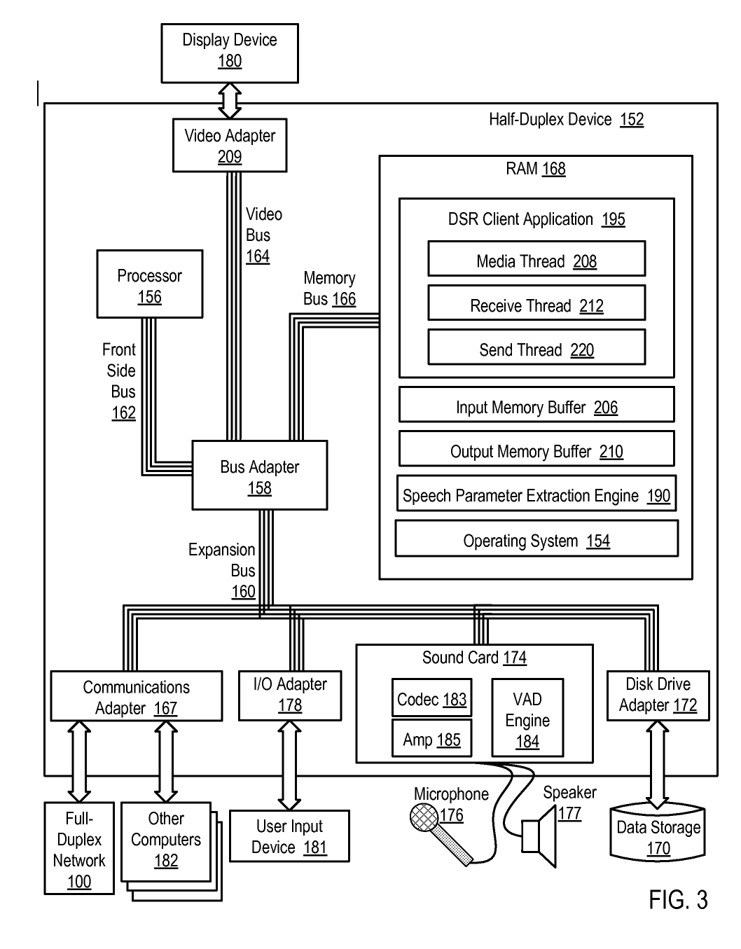

Streaming audio from a full-duplex network through a half-duplex device in accordance with the present invention is generally implemented with one or more half-duplex devices, that is, automated computing machinery or computers. In the system of FIG. 1, for example, all the half-duplex devices are implemented to some extent at least as computers. For further explanation, therefore, FIG. 3 sets forth a block diagram of automated computing machinery comprising an example of a computer useful as a half-duplex device (152) in streaming audio from a full-duplex network through a half-duplex device according to embodiments of the present invention. The half-duplex device (152) of FIG. 3 includes at least one computer processor (156) or ‘CPU’ as well as random access memory (168) (‘RAM’) which is connected through a high speed memory bus (166) and bus adapter (158) to processor (156) and to other components of the half-duplex device.

Stored in RAM (168) is a DSR client application (195), a module of computer program instructions capable of carrying out streaming audio from a full-duplex network through a half-duplex device according to embodiments of the present invention by buffering, in the half-duplex device, input audio from the full-duplex network, where the input audio is composed of audio data for output through the half-duplex device; playing, through the half-duplex device, the buffered input audio; pausing, during voice activity on the half-duplex device, the playing of the buffered input audio; recording, during the voice activity, output audio to be sent to the full-duplex network; and resuming the playing of the buffered input audio after the voice activity.

Also in RAM (168) is an input memory buffer (206). Input memory buffer (206) is a segment of memory organized by a data structure, such as, for example, a FIFO queue, as a buffer for temporary storage of input audio from a full-duplex network. The input audio is packets of computer data, digitally encoded packets of audio data to be output in sequence through the half-duplex device, that is, played through a sound card (174), decoded by a codec (183), amplified by an audio amplifier (185), and output through an audio speaker (177) to the ear of a user.

Also in RAM (168) is an output memory buffer (210). Output memory buffer (210) is a segment of memory organized by a data structure, such as, for example, a FIFO queue, as a buffer for temporary storage of recorded audio in a half-duplex device. The recorded audio is packets of computer data, digitally encoded packets of audio data, to be output in sequence from the half-duplex device to a full-duplex network.

Also in RAM (168) is a media thread (208) of the DSR client application (195). Media thread (208) is a set of computer program instructions capable of controlling a half-duplex device so as to play buffered input audio, pause the play of buffered input audio during voice activity on the half-duplex device, and record output audio during the voice activity.

Also in RAM (168) is a receive thread (212) of the DSR client application (195). Receive thread (212) is a set of computer program instructions capable of causing a half-duplex device to buffer input audio by receiving audio data through an input audio stream from a full-duplex network and storing the audio data in an input memory buffer.

Also in RAM (168) is a send thread (220) of the DSR client application (195). Send thread (220) is a set of computer program instructions capable of causing a half-duplex device to send recorded audio from an output memory buffer through an output audio stream to a full-duplex network.

Also stored in RAM (168) is a speech parameter extraction engine (190), a module of computer program instructions that accepts digitally encoded speech from a sound card (174), for example, extracts from the encoded speech parameters that describe the speech sufficiently to support speech recognition, and provides the parameterized speech to the DSR client application (195) for sending to a voice server.

Also stored in RAM (168) is an operating system (154). Operating systems useful in half-duplex devices according to embodiments of the present invention include UNIX™, Linux™, Microsoft NT™, AIX™, IBM's i5/OS™, and others as will occur to those of skill in the art. Operating system (154), half-duplex device application (195), VAD engine (184), and speech parameter extraction engine (190) in the example of FIG. 3 are shown in RAM (168), but many components of such software typically are stored in non-volatile memory also.

Half-duplex device (152) of FIG. 3 includes bus adapter (158), a computer hardware component that contains drive electronics for the high speed buses, the front side bus (162), the video bus (164), and the memory bus (166), as well as for the slower expansion bus (160). Examples of bus adapters useful in half-duplex devices according to embodiments of the present invention include the Intel Northbridge, the Intel Memory Controller Hub, the Intel Southbridge, and the Intel I/O Controller Hub. Examples of expansion buses useful in half-duplex devices according to embodiments of the present invention include Industry Standard Architecture (‘ISA’) buses and Peripheral Component Interconnect (‘PCI’) buses.

Half-duplex device (152) of FIG. 3 includes disk drive adapter (172) coupled through expansion bus (160) and bus adapter (158) to processor (156) and other components of the half-duplex device (152). Disk drive adapter (172) connects non-volatile data storage to the half-duplex device (152) in the form of disk drive (170). Disk drive adapters useful in half-duplex devices include Integrated Drive Electronics (‘IDE’) adapters, Small Computer System Interface (‘SCSI’) adapters, and others as will occur to those of skill in the art. In addition, non-volatile computer memory may be implemented for a half-duplex device as an optical disk drive, electrically erasable programmable read-only memory space (so-called ‘EEPROM’ or ‘Flash’ memory), RAM drives, and so on, as will occur to those of skill in the art.

The example half-duplex device of FIG. 3 includes one or more input/output (‘I/O’) adapters (178). I/O adapters in half-duplex devices implement user-oriented input/output through, for example, software drivers and computer hardware for controlling output to display devices such as computer display screens, as well as user input from user input devices (181) such as keyboards and mice. The example half-duplex device of FIG. 3 includes video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example half-duplex device of FIG. 3 also includes sound card (174), which is an example of an I/O adapter specially designed for accepting analog audio signals from a microphone (176) and converting the audio analog signals to digital form for further processing by a VAD engine (184) and a speech parameter extraction engine (190). Sound card (174) is connected to processor (156) through expansion bus (160), bus adapter (158), and front side bus (162).

The exemplary half-duplex device (152) of FIG. 3 includes a communications adapter (167) for data communications with other computers (182) and for data communications with full-duplex network (100). Such data communications may be carried out serially through RS-232 connections, through external buses such as a Universal Serial Bus (‘USB’), through data communications full-duplex networks such as IP full-duplex networks, and in other ways as will occur to those of skill in the art. Communications adapters implement the hardware level of data communications through which one computer sends data communications to another computer, directly or through a full-duplex network. Examples of communications adapters useful for streaming audio from a full-duplex network to a half-duplex device according to embodiments of the present invention include modems for wired dial-up communications, Ethernet (IEEE 802.3) adapters for wired full-duplex network communications, and 802.11b adapters for wireless full-duplex network communications.

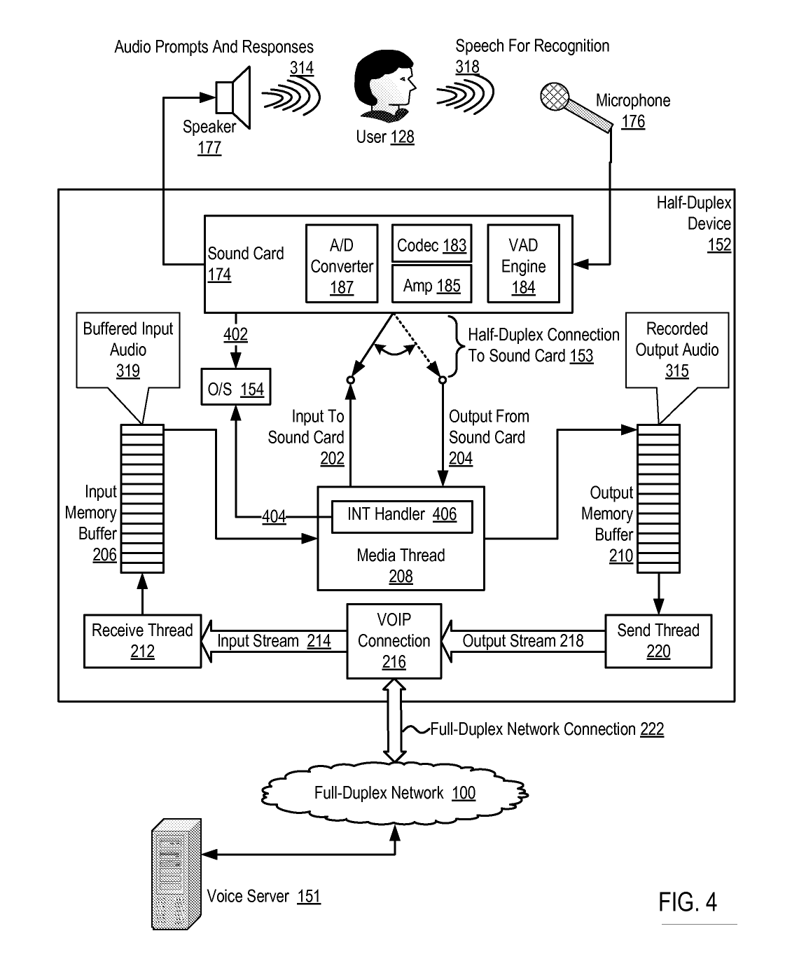

For further explanation, FIG. 4 sets forth a functional block diagram of exemplary apparatus for streaming audio from a full-duplex network through a half-duplex device according to embodiments of the present invention. The example of FIG. 4 includes a half-duplex device (152) that, as explained in more detail below, can play audio or record audio, but cannot do both at the same time.

The example half-duplex device (152) includes an input memory buffer (206), a segment of memory organized by a data structure, such as, for example, a FIFO queue, as a buffer for temporary storage of input audio from a full-duplex network (100). The example half-duplex device (152) also includes an output memory buffer (210), a segment of memory organized by a data structure, such as, for example, a FIFO queue, as a buffer for temporary storage of recorded audio to be sent in sequence from the half-duplex device (152) to a full-duplex network (100).

The example half-duplex device (152) also includes a media thread (208), which is, as explained in more detail below, a set of computer program instructions capable of controlling a half-duplex device so as to play buffered input audio (318), pause the play of buffered input audio (318) during voice activity on the half-duplex device, and record output audio (315) during the voice activity. The example half-duplex device (152) also includes a receive thread (212), a set of computer program instructions capable of causing a half-duplex device to buffer input audio by receiving audio data through an input audio stream (214) from a full-duplex network (100) and storing the audio data in an input memory buffer (206). The example half-duplex device (152) also includes a send thread (220), a set of computer program instructions capable of causing a half-duplex device to send recorded output audio (315) from an output memory buffer (210) through an output audio stream (218) to a full-duplex network (100). As mentioned above, the media thread (208), the receive thread (212), and the send thread (220) typically represent components of a DSR client application program of the half-duplex device. The example half-duplex device (152) also includes an operating system (154).

The example half-duplex device (152) includes a sound card (174) that in turn includes an analog-to-digital converter (187), a codec (183), an audio amplifier (185), and a voice activity detection (‘VAD’) engine. The analog-to-digital converter accepts an analog audio signal from a microphone (176) and converts the signal to digital form which is then encoded into a standard audio encoding format by codec (183) which then may be recorded in output memory buffer (210) to be sent to full-duplex network (100). Codec (183) is also capable of decoding buffered input audio (319) to be played to a user (128) through an audio speaker (177).

The sound card also includes a voice activity detection (‘VAD’) engine (184), a module of computer program instructions that detecting voice activity on the microphone (176) of the half-duplex device (152) and advises media thread (208) of the voice activity. There are a number of ways in which VAD engine (184) may detect voice activity:
The VAD engine (184) may detect voice activity by monitoring the state, on or off, a push-to-talk (‘PTT’) switch on the microphone (176).
The VAD engine (184) may detect voice activity by implementing a ‘voice operated switch’ or ‘VOX,’ an electronic switch that operates when a sound level over a certain threshold is detected. A VOX is a space-saving substitute for a push-to-talk switch on a half-duplex device. A VOX circuit usually includes a delay that leaves the circuit activated when the voice activity stops temporarily—to keep the circuit from turning off during short pauses in speech.
The VAD engine (184) may detect voice activity by accepting digitally encoded audio signals from A/D converter (187) and employing statistical techniques to filter out portions of the audio signals that represent mere noise or non-voice audio.
The VAD engine (184) may detect voice activity in other ways as will occur to those of skill in the art.

Having detected voice activity, the VAD engine (184) may advise media thread (208) of the voice activity by use of a VAD interrupt. That is, VAD engine (184) is configured to cause the sound card (174) to issue an operating system interrupt, referred to here as a ‘VAD interrupt’ (402), and media thread (208) is configured with an interrupt handler (406) that is registered (404) in the operating system (154) of the half-duplex device as a listener for VAD interrupts from the sound card. VAD interrupts in this example are of two types: one advising onset of voice activity and another advising cessation of voice activity.

Half-duplex device (152) is ‘half-duplex’ in this sense: The sound card (714) in this example can accept as input (202) buffered input audio (319) to play through a speaker (177) to a user (128) or the sound card can provide output (204) of digitized, encoded audio signals for media thread (208) to record, but the sound card cannot both accept input for playing and provide output for recording at the same time. Similarly, the media thread (208) is configured to provide buffered input audio (319) as input (202) to the sound card for playing to a user or to accept output (204) for recording, but not both at the same time.

Media thread (208) is configured to avoid loss of input audio, therefore, by playing buffered input audio (319) through the sound card (174) until receipt of a VAD interrupt indicating onset of voice activity. Then during voice activity, that is, before receipt of a next VAD interrupt indicating cessation of voice activity, the media thread records output from the sound card (174) in output memory buffer (210). After the voice activity, the media thread (208) resumes the playing of the buffered input audio (319). Because input audio packets from the full-duplex network are buffered during voice activity, when the half-duplex device records only, and playing of the buffered audio is resumed after voice activity, none of the input audio from the full-duplex network is lost. Rather than experiencing gaps in the input audio caused by packets dropped during recording, the user hears all the input audio from the full-duplex network. Playback of the input audio from the full-duplex network pauses while the user is speaking into the microphone, but no input audio from the full-duplex network is lost.

Moreover, the duration of a pause of playback of buffered input audio during voice activity is limited to the duration of the voice activity. This limitation occurs because the media thread (208) records output audio (315) in the output memory buffer (210). In effect, output audio is buffered in a manner similar to the buffering of input audio. Because the output audio is so recorded, the media thread can resume playing the buffered input audio as soon as voice activity ceases, with no need to block or wait while the recorded output audio is sent to the full-duplex network. Send thread (220) then sends the recorded output audio (315) to the full-duplex network, asynchronously with respect to the recording process, in accordance with a VOIP protocol.

VOIP, standing for ‘Voice Over Internet Protocol,’ is a generic term for routing speech over an IP-based full-duplex network. The speech data flows over a general-purpose packet-switched full-duplex network, instead of traditional dedicated, circuit-switched voice transmission lines. Protocols used to carry voice signals over the IP full-duplex network are commonly referred to as ‘Voice over IP’ or ‘VOIP’ protocols. VOIP traffic may be deployed on any IP full-duplex network, including full-duplex networks lacking a connection to the rest of the Internet, for instance on a private building-wide local area full-duplex network or ‘LAN.’

Many protocols are used to effect VOIP. The two most popular types of VoIP are effected with the IETF's Session Initian Protocol (‘SIP’) and the ITU's protocol known as ‘H.323.’ SIP clients use TCP and UDP port 5060 to connect to SIP servers. SIP itself is used to set up and tear down calls for speech transmission. VOIP with SIP then uses RTP for transmitting the actual encoded speech. Similarly, H.323 is an umbrella recommendation from the standards branch of the International Telecommunications Union that defines protocols to provide audio-visual communication sessions on any packet full-duplex network.

Methods for ‘COding/DECoding’ speech are referred to as ‘codecs.’ The European Telecommunications Standards Institute (‘ETSI’) provides several codecs for encoding speech for use in DSR, including, for example, the ETSI ES 201 108 DSR Front-end Codec, the ETSI ES 202 050 Advanced DSR Front-end Codec, the ETSI ES 202 211 Extended DSR Front-end Codec, and the ETSI ES 202 212 Extended Advanced DSR Front-end Codec. In standards such as RFC3557 entitled
RTP Payload Format for European Telecommunications Standards Institute (ETSI) European Standard ES 201 108 Distributed Speech Recognition Encoding
   and the Internet Draft entitled
RTP Payload Formats for European Telecommunications Standards Institute (ETSI) European Standard ES 202 050, ES 202 211, and ES 202 212 Distributed Speech Recognition Encoding,
   the IETF provides standard RTP payload formats for various codecs. It is useful to note, therefore, that there is no limitation in the present invention regarding codecs, payload formats, or packet structures. Speech for streaming audio from a full-duplex network through a half-duplex device according to embodiments of the present invention may be encoded with any codec, including, for example:
AMR (Adaptive Multi-Rate Speech coder)
ARDOR (Adaptive Rate-Distortion Optimised sound codeR),
Dolby Digital (A/52, AC3),
DTS (DTS Coherent Acoustics),
MP1 (MPEG audio layer-1),
MP2 (MPEG audio layer-2) Layer 2 audio codec (MPEG-1, MPEG-2 and non-ISO MPEG-2.5),
MP3 (MPEG audio layer-3) Layer 3 audio codec (MPEG-1, MPEG-2 and non-ISO MPEG-2.5),
Perceptual Audio Coding,
FS-1015 (LPC-10),
FS-1016 (CELP),
G.726 (ADPCM),
G.728 (LD-CELP),
G.729 (CS-ACELP),
GSM,
HILN (MPEG-4 Parametric audio coding), and
others as may occur to those of skill in the art.

In the example of FIG. 4, therefore, the VOIP connection (216) may implement a full-duplex network connection (222), through which audio may stream in both directions at the same time, as, for example, a Transmission Control Protocol (‘TCP’) connection using, for example, a socket implemented with a sockets application programming interface (‘API’) for TCP. The send thread (220) may attach an output audio stream to the socket, and the receive thread (212) may attach an input audio stream (214) to the socket. Then the send thread (220) may receive input audio from the full-duplex network through the input audio stream, and the receive thread (212) may send output audio to the full-duplex network through the output audio thread (218), both effectively at the same time.

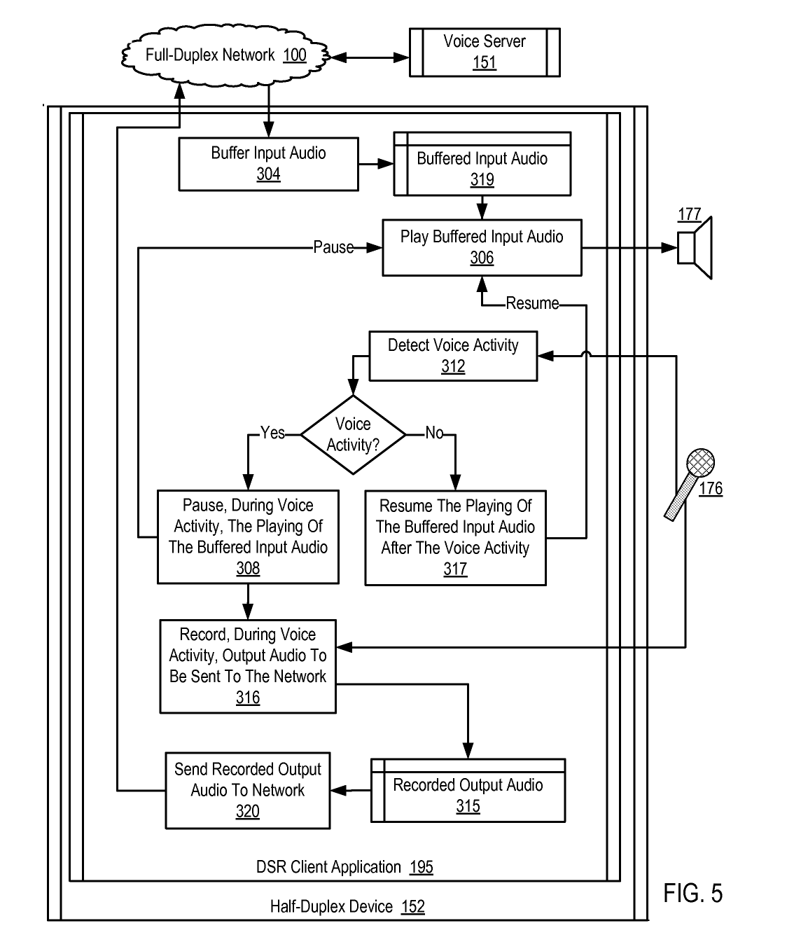

For further explanation, FIG. 5 sets forth a flow chart illustrating an exemplary method of streaming audio from a full-duplex network (100) through a half-duplex device (152) according to embodiments of the present invention. In the following discussion, the method of FIG. 5 is described with reference to the flow chart of FIG. 5 and also with reference to the system of FIG. 4.

The method of FIG. 5 includes buffering (304), in the half-duplex device, input audio (319) from the full-duplex network, the input audio comprising audio data for output through the half-duplex device. In the method of FIG. 5, the input audio from the full-duplex network (100) may be implemented as VOIP received through the full-duplex network (100) from a voice server (151), for example, and the half-duplex device may include a distributed speech recognition (‘DSR’) client (195). In the method of FIG. 5, buffering input audio may be carried out by receiving, by a receive thread (reference 212 on FIG. 4) that is a component of the DSR client application (195), audio data (as VOIP from the full-duplex network) through an input audio stream (214 on FIG. 4) and storing the audio data in an input memory buffer (206 on FIG. 4).

The method of FIG. 5 also includes playing (306), through the half-duplex device (152), the buffered input audio (319). In the method of FIG. 5, playing (306) the buffered input audio (319) may be implemented by playing the buffered input audio by a media thread (208 on FIG. 4). Such a media thread may be implemented as a component of DSR client application (195).

The method of FIG. 5 also includes detecting (312) voice activity on the half-duplex device. In the method of FIG. 5, detecting (312) voice activity on the half-duplex device may be carried out by detecting voice activity by a VAD engine (184 on FIG. 4) and advising, by the VAD engine, a media thread (208 on FIG. 4) of the voice activity. As described in more detail above, the VAD engine may advise the media thread of voice activity by use of a VAD interrupt.

The method of FIG. 5 also includes pausing (308), during voice activity on the half-duplex device, the playing (306) of the buffered input audio (318). In the method of FIG. 5, pausing (308) the playing of the buffered input audio may be implemented by pausing the playing of the buffered input audio by a media thread (208 on FIG. 4).

The method of FIG. 5 also includes recording (316), during the voice activity, output audio (315) to be sent to the full-duplex network. In the method of FIG. 5, recording (316) output audio (315) for delivery to the full-duplex network may be carried out by recording output audio by the media thread (208 on FIG. 4) in an output memory buffer (210 on FIG. 4).

The method of FIG. 5 also includes resuming (317) the playing (306) of the buffered input audio (318) after the voice activity. The method of FIG. 5 also includes sending (320) the recorded output audio by a send thread (220 on FIG. 4) to the full-duplex network (100).

In view of the explanations set forth above in this paper, readers will recognize that the benefits of streaming audio from a full-duplex network through a half-duplex device according to various embodiments of the present invention typically include an improved ability for a user to provide speech input for recognition through a DSR system with a greatly reduced risk of losing audio prompts or speech responses from the system during user voice activity.

Exemplary embodiments of the present invention are described largely in the context of a fully functional computer system for streaming audio from a full-duplex network through a half-duplex device. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone full-duplex networks for voice communications and digital data communications full-duplex networks such as, for example, Ethernets™ and full-duplex networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for streaming audio from a full-duplex network through a half-duplex device, the method comprising:
buffering, in the half-duplex device, input audio from the full-duplex network, the input audio comprising audio data for output through the half-duplex device;
playing, through the half-duplex device, the buffered input audio;
pausing, during voice activity on the half-duplex device, the playing of the buffered input audio;
recording, during the voice activity, output audio to be sent to the full-duplex network; and
resuming the playing of the buffered input audio after the voice activity.

2. The method of claim 1 wherein:
the input audio from the full-duplex network comprises voice over the internet protocol (‘VOIP’), and
the half-duplex device comprises a distributed speech recognition (‘DSR’) client.

3. The method of claim 1 wherein buffering input audio further comprises:
receiving, by a receive thread, audio data from an input audio stream; and
storing the audio data in an input memory buffer.

4. The method of claim 1 further comprising detecting the voice activity on the half-duplex device.

5. The method of claim 4 wherein detecting the voice activity on the half-duplex device further comprises:
detecting voice activity by a VAD engine; and
advising, by the VAD engine, a media thread of the voice activity.

6. The method of claim 1 wherein:
playing the buffered input audio further comprises playing the buffered input audio by a media thread;
pausing the playing of the buffered input audio further comprises pausing the playing of the buffered input audio by the media thread; and
recording output audio for delivery to the full-duplex network further comprises recording output audio by the media thread in an output memory buffer.

7. The method of claim 1 further comprising sending the recorded output audio by a send thread to the full-duplex network.

8. Apparatus for streaming audio from a full-duplex network through a half-duplex device, the apparatus comprising a computer processor and a computer memory operatively coupled to the computer processor, the computer memory having disposed within it computer program instructions capable of:
buffering, in the half-duplex device, input audio from the full-duplex network, the input audio comprising audio data for output through the half-duplex device;
playing, through the half-duplex device, the buffered input audio;
pausing, during voice activity on the half-duplex device, the playing of the buffered input audio;
recording, during the voice activity, output audio to be sent to the full-duplex network; and
resuming the playing of the buffered input audio after the voice activity.

9. The apparatus of claim 8 wherein:
the input audio from the full-duplex network comprises voice over the internet protocol (‘VOIP’), and
the half-duplex device comprises a distributed speech recognition (‘DSR’) client.

10. The apparatus of claim 8 wherein buffering input audio further comprises:
receiving, by a receive thread, audio data from an input audio stream; and
storing the audio data in an input memory buffer.

11. The apparatus of claim 8 further comprising a voice activity detection (‘VAD’) engine capable of detecting the voice activity on the half-duplex device.

12. The apparatus of claim 8 further comprising computer program instructions capable of sending the recorded output audio by a send thread to the full-duplex network.

13. A computer program product for streaming audio from a full-duplex network through a half-duplex device, the computer program product disposed upon a signal bearing medium, the computer program product comprising computer program instructions capable of:
buffering, in the half-duplex device, input audio from the full-duplex network, the input audio comprising audio data for output through the half-duplex device;
playing, through the half-duplex device, the buffered input audio;
pausing, during voice activity on the half-duplex device, the playing of the buffered input audio;
recording, during the voice activity, output audio to be sent to the full-duplex network; and
resuming the playing of the buffered input audio after the voice activity.

14. The computer program product of claim 13 wherein the signal bearing medium comprises a recordable medium.

15. The computer program product of claim 13 wherein the signal bearing medium comprises a transmission medium.

16. The computer program product of claim 13 wherein:
the input audio from the full-duplex network comprises voice over the internet protocol (‘VOIP’), and
the half-duplex device comprises a distributed speech recognition (‘DSR’) client.

17. The computer program product of claim 13 wherein buffering input audio further comprises:
receiving, by a receive thread, audio data from an input audio stream; and
storing the audio data in an input memory buffer.

18. The computer program product of claim 13 further comprising computer program instructions capable of detecting the voice activity on the half-duplex device.

19. The computer program product of claim 13 wherein:
playing the buffered input audio further comprises playing the buffered input audio by a media thread;
pausing the playing of the buffered input audio further comprise pausing the playing of the buffered input audio by the media thread; and
recording output audio for delivery to the full-duplex network further comprises recording output audio by the media thread in an output memory buffer.

20. The computer program product of claim 13 further comprising computer program instructions capable of sending the recorded output audio by a send thread to the full-duplex network.
